(19) United States
(12) Patent Application Publication
(10) Pub. No.: US 2026/0085575 A1
(43) Pub. Date: Mar. 26, 2026

(54) WINDOW OR DOOR HAVING A MODULAR SILL SYSTEM

(71) Applicant: Roto Frank Fenster- und Tuertechnologie GmbH, Leinfelden-Echterdingen (DE)

(72) Inventors: Choongeun Park, Stuttgart (DE); Martin Krebs, St. Johann (DE); Michael Metzger, Waldenbuch (DE); Richard Erb, Waldenbuch (DE)

(73) Assignee: Roto Frank Fenster- und Tuertechnologie GmbH, Leinfelden-Echterdingen (DE)

(21) Appl. No.: 19/347,540

(22) Filed: Oct. 1, 2025

Related U.S. Application Data
(63) Continuation of application No. PCT/EP2024/062134, filed on May 2, 2024.

(30) Foreign Application Priority Data
May 4, 2023 (DE) 102023204117.0

(51) Int. Cl. E06B 1/70; E06B 3/46; E06B 7/14

(52) U.S. Cl. CPC E06B 1/702; E06B 3/4609; E06B 7/14; E06B 2001/707

(57) ABSTRACT

A window or door has a fixed frame and leaf which, in its sliding position, can be slid in the extension direction or parallel to the extension direction of a running rail and which, transversely to the sliding direction, is movable in a positively controlled manner from its latching position into the sliding position and back into the latching position. The fixed frame has a sill modularly adaptable to different window and door variants with a main profile on which an intermediate profile is mounted. The intermediate profile has a first bearing portion, which bears against the fixed frame in a first sealing plane of the leaf. The sill may have a multitude of profiles which have a cross-section that remains constant in the extension direction. A second sealing plane is defined by a second bearing portion of the step profile.

### CROSS-REFERENCE TO RELATED APPLICATIONS

This continuation application claims priority to PCT/EP2024/062134 filed on May 2, 2024 which has published as WO 2024/227882 A1 and also the German application number DE 102023 204 117.0 filed on May 4, 2023, the entire contents of which are fully incorporated herein with these references.

### DESCRIPTION:

### FIELD OF THE INVENTION

The invention relates to a window or a door comprising a fixed frame and a leaf, wherein the leaf is movable transversely to the main plane of the fixed frame from a latching position (closed position) into a sliding position and back into the latching position and the leaf can be slid horizontally in or horizontally parallel to the main plane of the frame in the sliding position.

### BACKGROUND OF THE INVENTION

It is known to assemble a sill for a window or a door from several individual parts. Such sills have become known, for example, from the products Siegenia Eco Pass, Maco HS, Rehau Synego, Hautau ThermoTop and GU Thermostep.

DE 20009185 U1 further discloses a sill having several sill profiles for lift-and-slide doors.

DE 102016105941 A1 discloses a sill with a drainage chamber. The sill is designed to accommodate a running rail for guiding a sliding leaf.

DE 202016004456 U1 discloses a sill for a lift-and-slide leaf, which is intended to make a particularly unimpeded passage possible.

From JP 2004293229 A a sill for shoji leaves that can be slid parallel to one another has become known. Similar to DE 202016004456 U1, the sill is intended to enable particularly unimpeded passage.

DE 102016105941 A1 describes the use of a large flat sill with drainage openings.

DE 102017130894 A1, DE 102017130912 A1, DE 102019135411 A1, DE 102020102901 A1, DE 202017001325 U1, EP 3502399 B1, EP 3596295 B1 and NL 2004524 C disclose low-barrier lift-and-slide doors.

DE 102019211790 A1 and DE 102019211794 A1 disclose fittings for low-barrier sliding doors with transversely adjustable leaves (transverse to the extension of a running rail of the doors).

US 11,098,513 B2 and CN 204920573 U disclose further sills and fittings for transversely 'parking' leaves.

A disadvantage of known sills is that, in the case of high requirements for sealing a leaf to the fixed frame, they can be adapted only with great effort to different window or door variants, in particular, different opening variants (e.g., two leaves that are slidable / one slidable leaf and one fixed panel / one slidable leaf without a fixed panel / sliding leaves that can be latched to one another at the end face, etc.).

### SUMMARY OF THE INVENTION

Object of the invention

It is therefore an object of the invention to provide a window or a door with a sill which makes possible not only a reliable sealing of a leaf to a fixed frame but also a high degree of flexibility for adaptation to different window and door variants.

Description of the invention

This object is achieved according to the invention by a window or a door according to claim 1. The dependent claims reflect preferred embodiments.

The object according to the invention is thus achieved by a window or a door as mentioned above, wherein the fixed frame has a first sealing plane running in a vertical plane and a second sealing plane running in a vertical plane, wherein the first sealing plane runs horizontally offset from the second sealing plane and wherein the sealing planes seal the leaf towards the fixed frame when it bears against the fixed frame in the latching position. The fixed frame has a sill which has a main profile extending in or parallel to the main plane of the frame and an intermediate profile arranged on the main profile and extending in or parallel to the main plane of the frame. The intermediate profile has a first bearing portion for the leaf in the first sealing plane.

The intermediate profile, which is not formed on but is arranged on the main profile, makes possible a flexible definition of the first bearing portion or the first sealing plane. A relocation of the first bearing portion or the first sealing plane can be achieved by simply replacing the intermediate profile without complex milling work or use of a different main profile.

The leaf is preferably sealed completely in the first sealing plane and second sealing plane. The sealing of the leaf in the first sealing plane can run at least partially parallel to the sealing of the leaf in the second sealing plane, so that at least in part there is a multiple sealing of the leaf on the fixed frame.

The sill according to the invention is designed in the form of a floor sill and is particularly easily adaptable to different window and door variants.

In the sliding position, the leaf can be slid parallel to the main plane of the frame in the sliding direction. To enable the leaf to move transversely to the sliding direction, the leaf preferably has: a drive rod arrangement operable by a user; a carriage on the underside of the leaf, wherein the carriage has a leaf part fixedly arranged or formed on the leaf and a roller part with a running roller. The roller part is movable relative to the leaf part by actuating the drive rod arrangement in order to move the leaf from its latching position into its sliding position and back into the latching position.

The fixed frame has a running rail on which the running roller is supported, wherein the running rail extends in or parallel to the main plane of the frame, i.e., in particular, in the sliding direction.

The leaf can moreover include an operable handle coupled to the drive rod assembly for moving the leaf from its latching position into the sliding position and back into the latching position. The drive rod arrangement can also be designed in the form of a cord running around the leaf.

Preferably, the sill has a running rail profile with the running rail, wherein the running rail profile is arranged on the main profile and extends in or parallel to the main plane of the frame.

The running rail profile can be screwed to the main profile and/or locked to the main profile.

The intermediate profile can be screwed to the main profile. Alternatively or additionally, the intermediate profile can be locked to the main profile.

In a further preferred embodiment of the invention, the sill has a base profile arrangement. The base profile arrangement has an outside profile and an inside profile, wherein the main profile is arranged or formed, in particular, horizontally, between the outside profile and the inside profile.

Preferably, the outside profile and/or the inside profile is/are not formed integrally with the main profile but is/are arranged on the main profile. As a result, the sill has a particularly modular design. The outside profile and/or the inside profile can be locked to the main profile.

The base profile arrangement can have a U-shaped cross-section.

The upper side of the outside profile and the upper side of the inside profile are preferably of the same height so that they define a horizontal plane. At least one post of the window or door can be placed on this horizontal plane, the base plane, wherein the post can be cut off straight, so that an elaborate counter-milling is not necessary. The first sealing plane and the second sealing plane preferably extend at a right angle to this base plane.

To further increase the flexibility of the sill, the sill can have a top profile on the main profile, in particular, on the base profile arrangement, which extends in or parallel to the main plane of the frame.

The top profile can be arranged in a fixed panel region and/or in a passage region of the fixed frame, wherein the passage region can be opened or closed by sliding the leaf.

The top profile can have a sealing lip, particularly on the underside. The sealing lip preferably extends in or parallel to the main plane of the frame.

Further preferably, the sill can have a counter-block which is arranged on the end face of the top profile. The counter-block makes it possible to seal the end face of the top profile without or using small amounts of liquid sealant (e.g., silicone) or other sealing materials (e.g., butyl adhesive). The counter-block can comprise an elastic sealing material, in particular, rubber, preferably ethylene propylene diene (monomer) rubber (EPDM). Particularly preferably, the counter-block is made of elastic sealing material, in particular, rubber, preferably EPDM.

The counter-block can be screwed onto the top profile. A screwed connection ensures sufficient contact pressure of the counter-block on the top profile. Preferably, the top profile has at least one screw channel. The screw channel preferably runs in or parallel to the main plane of the frame. Further preferably, the top profile has a further screw channel which runs in particular, parallel to the screw channel.

In a preferred method aspect of the invention, the top profile is mounted on the base profile arrangement with the counter-block already attached thereto. Such pre-mounting has a positive effect on the ease of mounting and on the mounting time.

In order to promote water drainage, the sill can have a further top profile arranged on the main profile, in particular, on the base profile arrangement, which is aligned with but arranged at a distance from the top profile.

The sill can have a step profile that extends in or parallel to the main plane of the frame.

The step profile preferably has a second bearing portion for the leaf in the second sealing plane.

The step profile preferably has an inclined or sloping upper side to improve water drainage.

The step profile can be arranged on the top profile and/or supported thereon. The top profile can have at least one receptacle for the step profile.

Water drainage is promoted if the sill has a weatherboard profile that extends in or parallel to the main plane of the frame, wherein the weatherboard profile is arranged at a distance from the base profile arrangement via a weatherboard holder.

The weatherboard profile is preferably screwed onto the base profile arrangement, wherein a screw penetrates, in particular, the weatherboard holder.

The sill can have a glass strip profile that extends in or parallel to the main plane of the frame. The glass strip profile can be arranged on the base profile arrangement.

The glass strip profile can be screwed onto the base profile arrangement and/or locked into the base profile arrangement. The glass strip profile preferably bears directly, or via a sealing lip, against a glass pane of the window or door. The glass strip profile makes particularly deep fixed-panel glazing possible, especially without a fixed-panel profile on the underside.

A glazing block can be provided between the top profile and the fixed-panel glazing.

Alternatively, the sill can have a fixed-panel profile on the top profile that extends in or parallel to the main plane of the frame.

In a particularly preferred embodiment of the invention, the sill has a ramp profile which is arranged, in particular, on the main profile. The ramp profile extends in or parallel to the main plane of the frame. The ramp profile preferably has an inclined or sloping upper side. The ramp profile can be arranged directly next to the running rail profile to facilitate passing the running rail. The ramp profile can be screwed onto the base profile arrangement and/or locked into the base profile arrangement.

As an alternative or in addition to the ramp profile, a covering profile can be arranged on the base profile arrangement. The covering profile extends in or parallel to the main plane of the frame. The covering profile can be screwed onto the base profile arrangement and/or locked into the base profile arrangement. The covering profile preferably has a horizontally flat upper side. The covering profile can be arranged between the top profile and the running rail profile to bridge the gap between these profiles, so that the sill is designed to be even more barrier-free.

In a further preferred embodiment of the invention, the fixed frame has a center post, wherein the sill in the region of the center post has a sealing cushion against which the leaf bears at least in portions in the latching position.

The sealing cushion in the region of the center post, together with the intermediate profile, particularly effectively prevents rainwater from penetrating the interior. Particularly preferably, the sealing cushion connects the first sealing plane to the second sealing plane. The sealing cushion can be designed in the form of a right angle. Alternatively or additionally, the sealing cushion is part of the upper side of the sill. A projection can be arranged on the underside of the leaf, which bears against the sealing cushion when the leaf is in the latching position.

One or more, in particular, all, of the aforementioned profiles preferably have a cross-section that remains constant in the extension direction. Alternatively or additionally, one or more, in particular, all, of the aforementioned profiles can be designed in the form of an extruded profile.

Each sill described herein constitutes an independent aspect of the invention. Furthermore, each window and each door described herein and having a leaf and a fixed frame and a sill described herein constitute an independent aspect of the invention. These independent aspects of the invention can be combined as desired with all features described herein.

Further advantages of the invention can be found in the description and the drawings. Likewise, according to the invention, the aforementioned features and those which are to be explained below can each be used individually or together in any desired combinations. The embodiments shown and described are not understood as an exhaustive list, but, rather, have an exemplary character for the description of the invention.

### BRIEF DESCRIPTION OF THE DRAWINGS

FIG. 1a shows a partial sectional view of a door with a fixed frame and a leaf movable relative to the fixed frame. The leaf is supported on the underside by a carriage on a sill of the fixed frame. The leaf is in the sliding position.

FIG. 1b shows the door from FIG. 1a with the leaf in the latching position.

FIG. 1c shows an enlarged representation of the door from FIG. 1b with two indicated sealing planes of the leaf on the fixed frame.

FIG. 2 shows a partial sectional view of the fixed frame from FIG. 1c with the sealing planes indicated.

FIG. 3 shows a sectional view of a base profile arrangement of the sill from FIG. 2 with a base plane indicated.

FIG. 4 shows a part of a fixed frame of a door with a sill, wherein the sectional view of the sill is located in a passage region of the door.

FIG. 5 shows a part of a fixed frame of a door with a sill, wherein the sectional view is located in a fixed panel region in which no fixed-panel profile of the fixed frame is present.

FIG. 6 shows, like FIG. 5, a part of a fixed frame of a door with a sill, wherein the sectional view is located in a fixed panel region in which a fixed-panel profile of the fixed frame is present.

FIG. 7a shows a partial sectional view of a fixed frame of a door, wherein the fixed frame has a sill, posts and a fixed-panel glazing.

FIG. 7b shows a plan view of the fixed frame from FIG. 7a.

FIG. 8a shows a perspective view of a sill with a base profile arrangement and top profiles placed thereon, to which counter-blocks are partially mounted.

FIG. 8b shows a plan view of the sill from FIG. 8a.

FIG. 8c shows a sectional view of a sill with a base profile arrangement with installed top profiles and counter-blocks in a passage region.

FIG. 8d shows the sill from FIG. 8c in the fixed panel region.

### DETAILED DESCRIPTION OF EMBODIMENTS OF THE INVENTION

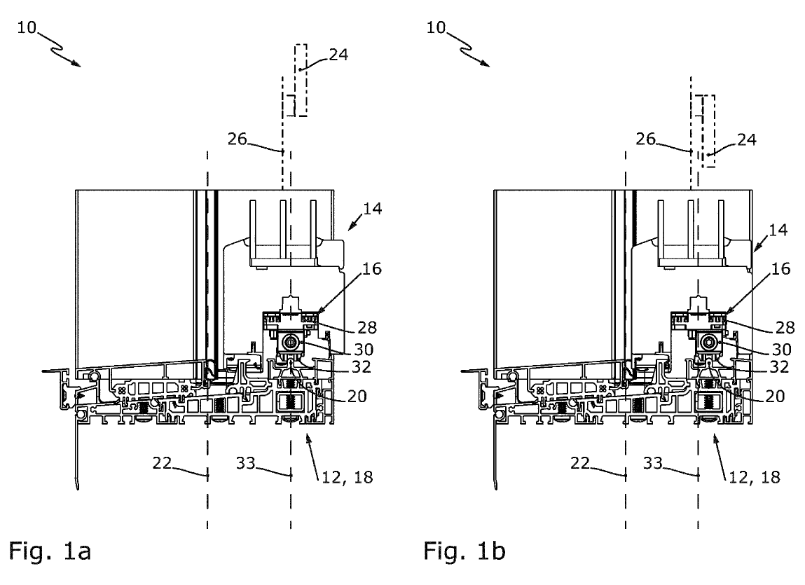

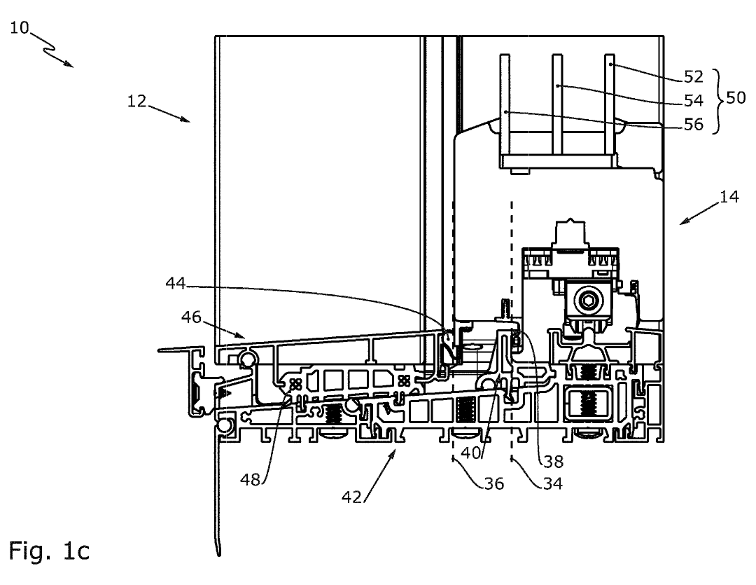

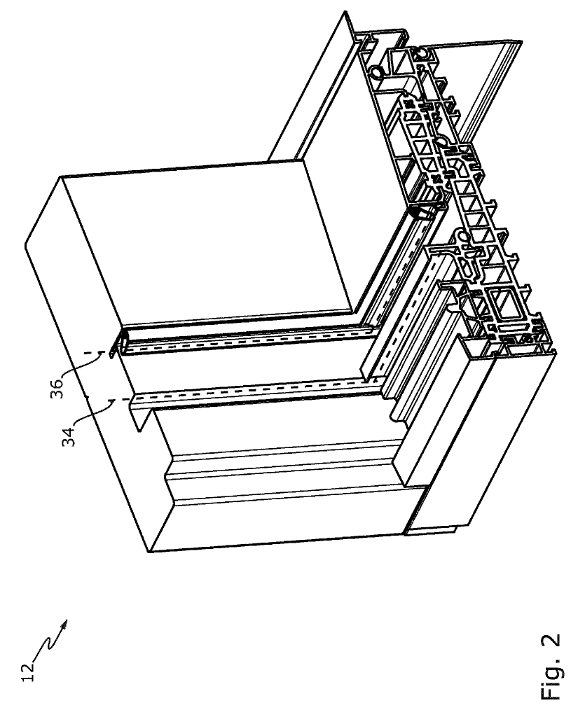

FIG. 1a shows a door 10 with a fixed frame 12 and a leaf 14 movable relative to the fixed frame 12. The leaf 14 is supported on the underside by a carriage 16 on a sill 18, i.e., a ground sill.

FIG. 1a shows the leaf 14 in a sliding position, i.e., it can be moved by a user to open or close a passage of the door 10. Sliding of the leaf 14 takes place parallel to the extension of a running rail 20 or in the direction of the running rail 20 (perpendicular to the plane of the paper in FIG. 1a). In FIG. 1a, a main plane 22 of the fixed frame 12 also runs perpendicular to the plane of the paper. The leaf 14 is thus slidable parallel to or in the main plane 22 of the fixed frame 12 in order to open or close a passage.

FIG. 1b shows the door 10 with the fixed frame 12 and the leaf 14 according to FIG. 1a, wherein the leaf 14 is in a latching position. The leaf 14 can be moved transversely, in particular, perpendicularly, to the main plane of the frame 22 in order to be moved in a positively controlled manner from the sliding position shown in FIG. 1a into the latching position shown in FIG. 1b. Furthermore, the leaf 14 can be moved in a positively controlled manner from the latching position shown in FIG. 1b into the sliding position shown in FIG. 1a.

From a combination of FIGS. 1a and 1b it can be seen - schematically indicated - that the movement of the leaf 14 transversely to the main plane of the frame 22 can be achieved by actuating a handle 24. The movement, in particular, the pivoting, of the handle 24 can be transferred to the carriage 16 by a drive rod arrangement 26.

The carriage 16 has a leaf part 28 that is fixed to the leaf 14 and a roller part 30 that is movable relative to the leaf part 28. The roller part 30 has a running roller 32 which is supported on the running rail 20. Actuation of the handle 24 thus causes a movement of the roller part 30 transverse to a main plane of the leaf 33 which extends parallel to the main plane of the frame 22, so that the leaf 14 is moved transversely to the main plane of the frame 22.

FIG. 1c shows an enlarged representation of the underside structure of the door 10 according to FIG. 1b. FIG. 1c shows that the leaf 14 bears against the fixed frame 12 in a first sealing plane 34 and in a second sealing plane 36. The first sealing plane 34 is defined in portions by the position of a first bearing portion 38 of an intermediate profile 40. The intermediate profile 40 is mounted on a main profile 42. Since the intermediate profile 40 is not formed integrally (in one piece) with the main profile 42, it can be replaced for the displacement of the first sealing plane 34 without having to use a completely different sill 18.

The second sealing plane 36 is preferably defined in portions by a second bearing portion 44 of a step profile 46. In the present case, the second bearing portion 44 is designed in the form of a stop seal, here in the form of a sealing strip. Replacing or offsetting the step profile 46 allows the second bearing portion 44 to be easily adapted. In the exemplary embodiment shown, the step profile 46 is mounted on the main profile 42 via a top profile 48.

The door 10 is, in particular, watertight and heat-insulating due to the two sealing planes 34, 36. The leaf 14 has a leaf glazing 50 with several panes 52, 54, 56, here at least three panes 52, 54, 56.

FIG. 2 shows an isometric view of a part of the fixed frame 12 with the sealing planes 34, 36. The sealing of the leaf 14 (see FIG. 1c) on the fixed frame 12 is preferably implemented circumferentially, in particular, rectangularly circumferentially, in the first sealing plane 34 and/or the second sealing plane 36.

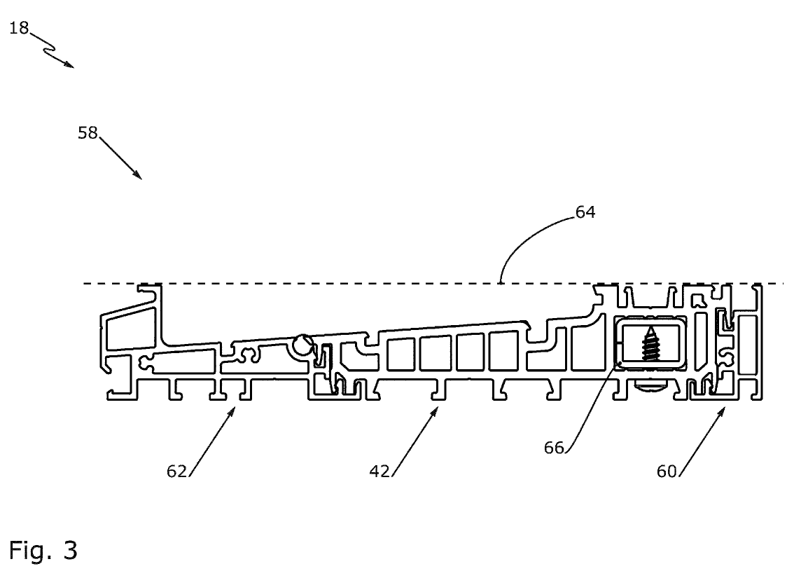

FIG. 3 shows a part of the sill 18, more precisely a base profile arrangement 58 of the sill 18. The base profile arrangement 58 has the main profile 42, an inside profile 60 and an outside profile 62. The main profile 42 is arranged between the inside profile 60 and the outside profile 62, wherein the connection is made via end faces of the profiles 42, 60, 62.

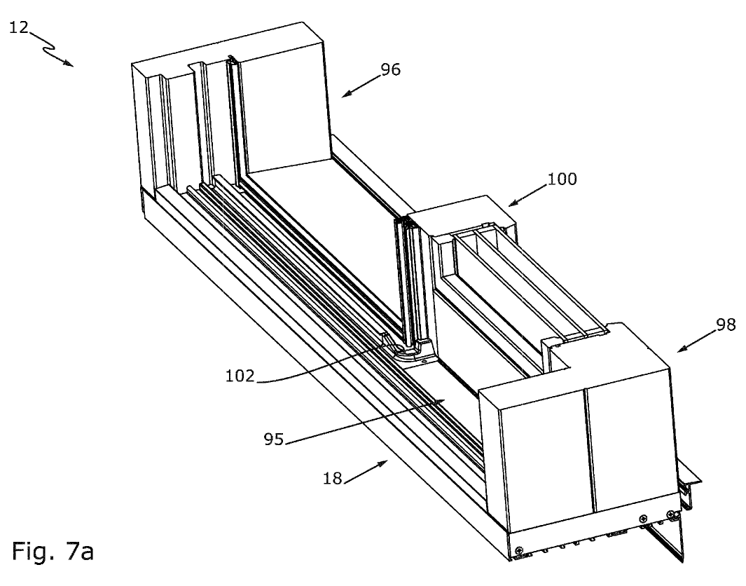

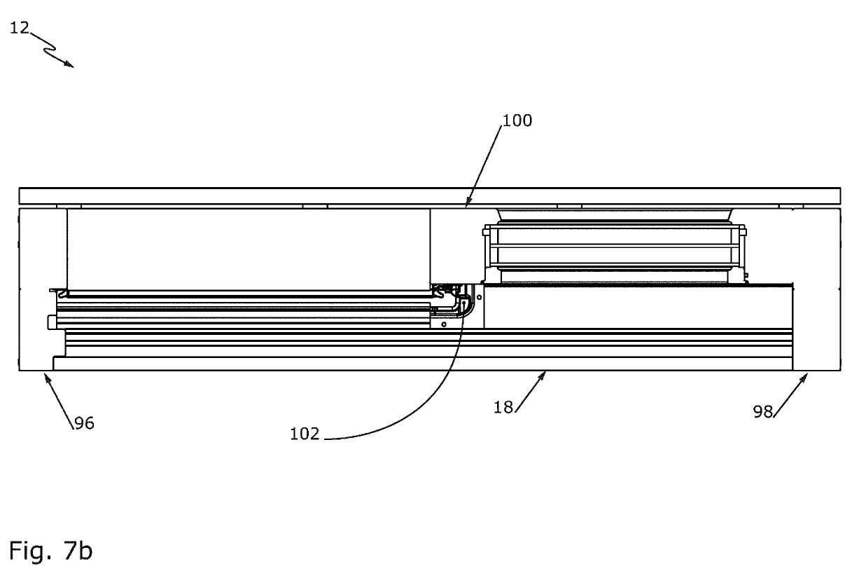

The base profile arrangement 58 is U-shaped in cross-section, wherein both legs in the mounted state of the base profile arrangement 58 have the same vertical height and define a horizontal base plane 64. The horizontal base plane 64 facilitates the placement of at least one post with a flat underside (see posts 96, 98, 100 according to FIG. 7a), i.e., without counter-milling on the underside.

The base profile arrangement 58 is reinforced by a reinforcement profile 66, which is screwed, in particular, into the base profile arrangement 58, preferably the main profile 42. The reinforcement profile 66 is particularly preferably provided below the running rail 20 (see FIG. 1b).

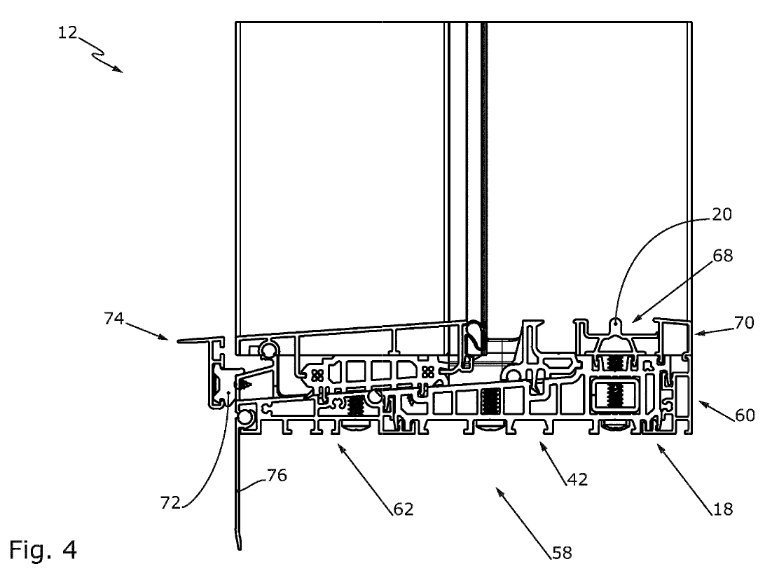

FIG. 4 shows a fixed frame 12 with a sill 18. FIG. 4 shows that the running rail 20 is formed in a running rail profile 68.

A ramp profile 70, in particular, having a beveled upper side, can be arranged in the region of the running rail profile 68, in particular, directly next to the running rail profile 68. The ramp profile 70 is preferably mounted on the base profile arrangement 58, in particular, on the main profile 42 and/or the inside profile 60.

A weatherboard holder 72 is mounted on the base profile arrangement 58, here the outside profile 62, which holds a weatherboard profile 74 at a distance from the base profile arrangement 58, here at a distance from the outside profile 62. The spacing of the weatherboard profile 74 permits efficient water drainage.

Alternatively or additionally, a vertical sealing strip 76 can be provided on the base profile arrangement 58, in particular, on the outside profile 62. The vertical sealing strip 76 extends with a largely, in particular, completely, constant cross-section in the horizontal direction and projects vertically downwards.

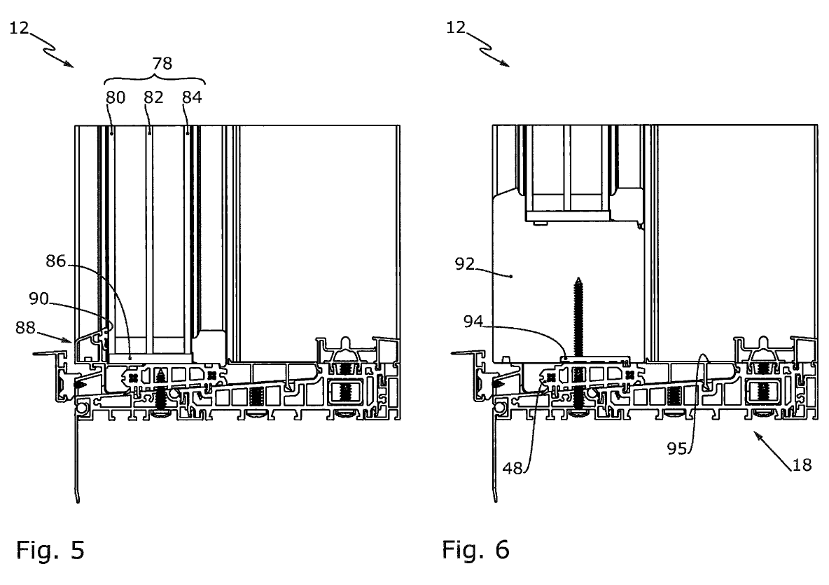

FIG. 5 shows a sectional view through the frame 12 in the fixed panel region. A fixed-panel glazing 78 with at least three panes 80, 82, 84 is particularly deep and has a glazing block 86 on the underside. The deep fixed-panel glazing 78 benefits from a glass strip profile 88, here with a sealing lip 90 on the fixed-panel glazing 78.

FIG. 6 shows a fixed frame 12 in the fixed panel region, wherein the fixed frame 12 has a solid fixed-panel frame 92. The fixed-panel frame 92 is supported by a fixed-panel profile 94 of the sill 18 on the underside. The fixed-panel profile 94 rests, in particular, on the top profile 48.

The sill 18 is formed by a covering profile 95, in a significantly barrier-poorer manner.

FIGS. 7a, 7b show a fixed frame 12 with a sill 18 having a covering profile 95, on which outer posts 96, 98 and a center post 100 are mounted. A sealing cushion 102 is arranged in the region of the center post 100. The sealing cushion 102 connects, in particular, the sealing planes 34, 36 (see FIG. 2).

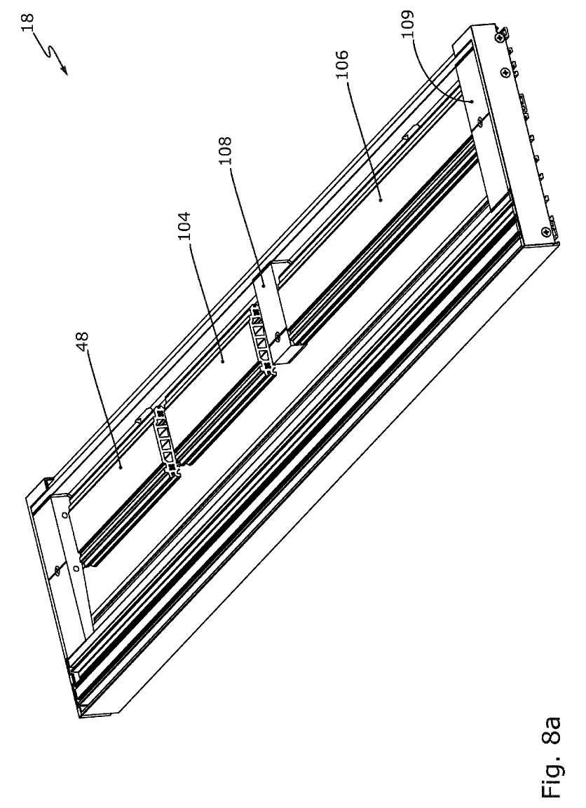

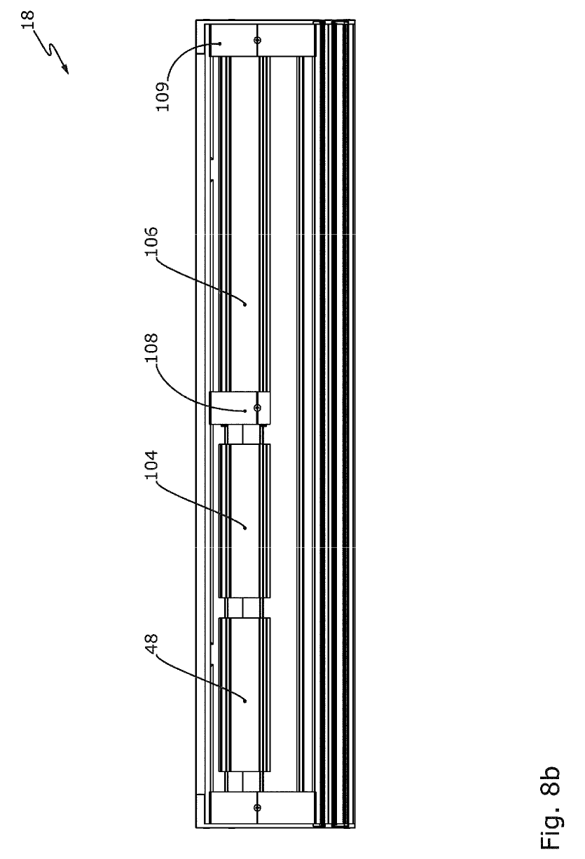

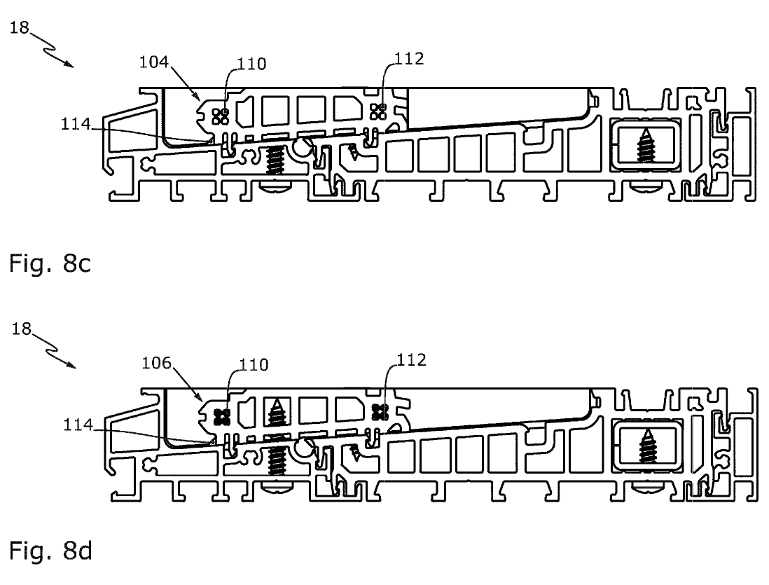

FIGS. 8a, 8b show a sill 18 with the top profile 48 and further top profiles 104, 106. At least two top profiles 48, 104, 106 can be arranged in alignment but at a distance from one another in order to promote water drainage. At least one counter-block 108, 109 can be provided on the end face of at least one top profile 48, 104, 106, here on the top profile 106, in particular, facing another top profile 48, 104. The counter-block 108, 109 can be pre-mounted on the top profile 106 to minimize on-site construction time. The counter-block 108, 109 facilitates sealing while avoiding or reducing the use of liquid sealants.

FIGS. 8c, 8d show the sill 18 according to FIGS. 8a, 8b in a sectional view, wherein FIG. 8c shows the sill 18 in the passage region and FIG. 8d shows the sill 18 in a fixed panel region. From FIGS. 8c, 8d it can be seen that the top profile 104, 106 has screw channels 110, 112 for fastening the counter-block 108, 109 (see FIGS. 8a, 8b). The underside of the top profile 104, 106 is sealed by a sealing lip 114.

When all figures of the drawing are viewed in combination, the invention relates, in summary, to a window or a door 10 comprising a fixed frame 12 and a leaf 14 which, in its sliding position, can be slid in the extension direction or parallel to the extension direction of a running rail 20 and which, transversely to the sliding direction, is movable in a positively controlled manner from its latching position into the sliding position and back into the latching position. The fixed frame 12 has a sill 18 which is, in particular, modularly adaptable to different window and door variants. The sill 18 has a main profile 42 on which an intermediate profile 40 is mounted. The intermediate profile 40 has a first bearing portion 38, which bears against the fixed frame 12 in a first sealing plane 34 of the leaf 14. The sill 18 can furthermore have a step profile 46, a top profile 48, 104, 106, an inside profile 60, an outside profile 62, a reinforcement profile 66, a running rail profile 68, a ramp profile 70, a weatherboard profile 74, a glass strip profile 88, a fixed-panel profile 94 and/or a covering profile 95. All of the aforementioned profiles 42, 40, 46, 48, 104, 106, 60, 62, 66, 68, 70, 74, 88, 94, 95 preferably have a cross-section that remains essentially, in particular, entirely constant in the extension direction. A second sealing plane 36 is preferably defined by a second bearing portion 44 of the step profile 46.

### List of Reference Signs:

10 Door

12 Fixed frame

14 Leaf

16 Carriage

18 Sill

20 Running rail

22 Main plane of the frame

24 Handle

26 Drive rod arrangement

28 Leaf part

30 Roller part

32 Running roller

33 Main plane of the leaf

34 First sealing plane

36 Second sealing plane

38 First bearing portion

40 Intermediate profile

42 Main profile

44 Second bearing portion

46 Step profile

48 Top profile

50 Leaf glazing

52 Pane

54 Pane

56 Pane

58 Base profile arrangement

60 Inside profile

62 Outside profile

64 Base plane

66 Reinforcement profile

68 Running rail profile

70 Ramp profile

72 Weatherboard holder

74 Weatherboard profile

76 Vertical sealing strip

78 Fixed-panel glazing

80 Pane

82 Pane

84 Pane

86 Glazing block

88 Glass strip profile

90 Sealing lip

92 Fixed-panel frame

94 Fixed-panel profile

95 Covering profile

96 Outer post

98 Outer post

100 Center post

102 Sealing cushion

104 Further top profile

106 Further top profile

108 Counter-block

109 Counter-block

110 Screw channel

112 Screw channel

114 Sealing lip

What is claimed is:

1. A window or a door comprising:
a fixed frame and a leaf, wherein the leaf is movable transversely to the main plane of the fixed frame from a latching position into a sliding position and back into the latching position and can be slid parallel to the main plane of the frame in the sliding position;
wherein the fixed frame has a vertically running first sealing plane and a vertically running second sealing plane, wherein the first sealing plane is horizontally offset from the second sealing plane, wherein the leaf is sealed in the latching position in the sealing planes by bearing against the fixed frame;
wherein the fixed frame has a sill;
wherein the sill has a main profile extending horizontally in or horizontally parallel to the main plane of the frame and an intermediate profile arranged on the main profile and extending horizontally in or horizontally parallel to the main plane of the frame; and
wherein the intermediate profile has a first bearing portion for the leaf in the first sealing plane.

2. The window or the door according to claim 1, wherein the leaf has:
an actuatable drive rod arrangement;
a carriage on the underside of the leaf, wherein the carriage has a leaf part which is arranged or formed fixedly on the leaf and a roller part with a running roller;
wherein the roller part is movable in a positively controlled manner transversely to the main plane of the leaf by actuation of the drive rod arrangement in order to be able to move the leaf transversely to the main plane of the frame from its latching position into its sliding position and back into the latching position;
and wherein the fixed frame has:
a running rail on which the running roller is supported, wherein the running rail extends horizontally in or horizontally parallel to the main plane of the frame.

3. The window or the door according to claim 2, wherein the sill has a running rail profile which is arranged on the main profile, wherein the running rail profile extends horizontally in or horizontally parallel to the main plane of the frame, and wherein the running rail is formed in the running rail profile.

4. The window or the door according to claim 1, wherein the intermediate profile is locked to the main profile.

5. The window or the door according to claim 1, wherein the sill has a base profile arrangement, wherein the base profile arrangement has an outside profile which is arranged or formed on its longitudinal end face on a longitudinal end face of the main profile, and wherein the base profile arrangement has an inside profile which is arranged or formed on a longitudinal end face on a further longitudinal end face of the main profile, wherein the main profile is arranged or formed between the outside profile and the inside profile.

6. The window or the door according to claim 5, wherein the base profile arrangement is U-shaped in cross-section.

7. The window or the door according to claim 6, wherein the sill has a top profile arranged on the base profile arrangement, wherein the top profile extends horizontally in or horizontally parallel to the main plane of the frame.

8. The window or the door according to claim 7, wherein the sill has a counter-block which is arranged on the end face of the top profile.

9. The window or the door according to claim 8, wherein the sill has a further top profile arranged on the base profile arrangement, wherein the further top profile is aligned with the top profile but is arranged at a distance from the top profile in order to allow water to flow between the top profile and the further top profile.

10. The window or the door according to claim 7, wherein the sill has a further top profile arranged on the base profile arrangement, wherein the further top profile is aligned with the top profile but is arranged at a distance from the top profile in order to allow water to flow between the top profile and the further top profile.

11. The window or the door according to claim 5, wherein the sill has a top profile arranged on the base profile arrangement, wherein the top profile extends horizontally in or horizontally parallel to the main plane of the frame.

12. The window or the door according to claim 11, wherein the sill has a counter-block which is arranged on the end face of the top profile.

13. The window or the door according to claim 12, wherein the sill has a further top profile arranged on the base profile arrangement, wherein the further top profile is aligned with the top profile but is arranged at a distance from the top profile in order to allow water to flow between the top profile and the further top profile.

14. The window or the door according to claim 11, wherein the sill has a further top profile arranged on the base profile arrangement, wherein the further top profile is aligned with the top profile but is arranged at a distance from the top profile in order to allow water to flow between the top profile and the further top profile.

15. The window or the door according to claim 1, wherein the sill has a step profile, wherein the step profile extends horizontally in or horizontally parallel to the main plane of the frame.

16. The window or the door according to claim 5, wherein the sill has a weatherboard profile extending horizontally in or horizontally parallel to the main plane of the frame, which weatherboard profile is arranged on the base profile arrangement via a weatherboard holder of the sill, wherein the weatherboard profile is held at a distance from the base profile arrangement by means of the weatherboard holder in order to allow water to drain between the weatherboard profile and the base profile arrangement.

17. The window or the door according to claim 5, wherein the sill has a glass strip profile which is arranged on the base profile arrangement, wherein the glass strip profile extends horizontally in or horizontally parallel to the main plane of the frame.

18. The window or the door according to claim 5, wherein the sill has a ramp profile which is arranged on the base profile arrangement, wherein the ramp profile extends horizontally in or horizontally parallel to the main plane of the frame and preferably has an inclined upper side.

19. The window or the door according to claim 5, wherein the sill has a covering profile which is arranged on the base profile arrangement, wherein the covering profile extends horizontally in or horizontally parallel to the main plane of the frame.

20. The window or the door according to claim 1, wherein the fixed frame has a center post, wherein the sill has a sealing cushion in the region of the center post, against which the leaf bears at least in portions in the latching position.
